(19) United States
(12) Patent Application Publication
(10) Pub. No.: US 2009/0197013 A1
(43) Pub. Date: Aug. 6, 2009

(54) PRODUCING A FLEXOGRAPHIC PRINTING PLATE

(75) Inventors: Martin Philip GOUCH, Hemel Hempstead (GB); Christoph BITTNER, Hemel Hempstead (GB)

Correspondence Address: KENYON & KENYON LLP, RIVERPARK TOWERS, SUITE 600, 333 W. SAN CARLOS ST., SAN JOSE, CA, 95110, US

(73) Assignee: FFEI LIMITED, Hertfordshire (GB)

(21) Appl. No.: 12/025,567

(22) Filed: Feb. 4, 2008

(51) Int. Cl. B05B 5/025; B05D 1/36; B05D 3/06

(52) U.S. Cl. 427/558; 427/265; 118/621

(57) ABSTRACT

A method of producing a flexographic printing plate, comprises:

a) inkjet printing a layer of flexographic material in a predetermined pattern onto a substrate;

b) partially curing at least part of the printed layer of flexographic material so as to immobilize it on the substrate; and

c) repeating steps (a) and (b) so as to print and partially cure one or more further layers of flexographic material in the predetermined pattern on the previous layer(s),

characterized by additionally curing one or more lower printed layers before or while printing one or more upper layers so as to reduce spreading of the lower printed layer(s).

### FIELD OF THE INVENTION

The invention relates to methods and apparatus for producing a flexographic printing plate.

### DESCRIPTION OF THE PRIOR ART

Flexographic printing plates are used widely in letter press printing and the like, particularly for printing on surfaces which are soft and easily deformable such as packaging materials. The plates are typically prepared from photopolymerizable compositions comprising an elastomeric binder, at least one monomer and a photo-initiator.

The manufacture of flexographic plates is a relatively slow process since it involves several manufacturing stages. A plate is typically made from three layers. A UV transparent support layer, a layer of uncured flexographic material such as rubber, and an upper light sensitive UV mask material. The light sensitive UV mask is exposed to UV-A irradiation with the print image required, and developed. Then the flexographic material is exposed with UV-A Light from the rear and above to cure the areas that need to be retained. The mask material and the unexposed flexographic material is then removed with a washing, etching or erosion process. Then the remaining flexographic material is first dried and then hardened with the exposure of more UV-A and finally UV-C radiation.

This process has a number of drawbacks in that it is very labour intensive, it has high environmental impact in that the removed material needs to be disposed of, and the time taken for all these stages is slow. A typical elapsed time is 3 hrs.

Another drawback to this process is that areas with large solid tints require high pressures that contact point between paper and plate to ensure good ink transfer over the whole of the print area and leave no missing print areas or pin holes in the printed region. To produce this high print pressure it is normal to have a stiff backing to the plate to enable the pressure to be exerted through the plate. The high print pressure require for large solid tints is not desirable for the toned areas though as in the tonal regions the high pressure causes distortion of the raised printing surface and unwanted dot growth occurs. It is thus desirable to have a softer backing in the tonal regions to reduce the pressure in the tonal regions.

An alternative approach described in US-A-2004/0131778 incorporated herein by reference involves depositing flexographic material using an inkjet printer and using UV pin curing to hold the desired shape.

Pin curing is defined herein as sufficiently curing the material to immobilize it on the underlying surface but without necessarily fully curing the material.

This recently developed approach enables the flexographic plate to be produced in fewer stages and with much less wastage of material. In this process, the flexographic plate is built up by printing successive layers of the flexographic material, each layer being partially cured or pin cured to hold its shape prior to receiving the next layer and so that it is able to be wetted by the next layer. Typically, for a 0.5 mm relief height, about 60 layers of ink will need to be printed.

A problem with this technique is that although each layer is pin cured or immobilized, it has been found that firstly the pin curing or immobilizing will not remain in effect for the time taken to print the upper layers and secondly, due to the weight of the upper layers, some lateral spreading of the lower layers or “creep” will occur. This will result in a derogation in the image which is finally printed using the printing plate.

One of the methods described in US-A-2004/0131778 could be used to reduce this effect by filling the gaps between the patterned flexographic material with a removable material which supports the flexographic material layers until they are finally cured. This fill material is then removed in a further processing stage, but this is undesirable as it produces additional waste which needs to be correctly disposed of and adds time to the overall manufacturing process.

### SUMMARY OF THE INVENTION

In accordance with a first aspect of the present invention, a method of producing a flexographic printing plate comprises

a) inkjet printing a layer of flexographic material in a predetermined pattern onto a substrate;

b) partially curing at least part of the printed layer of flexographic material so as to immobilize it on the substrate; and

c) repeating steps (a) and (b) so as to print and partially cure one or more further layers of flexographic material in the predetermined pattern on the previous layer(s),

characterized by additionally curing one or more lower printed layers before or while printing one or more upper layers so as to reduce spreading of the lower printed layer(s).

In accordance with a second aspect of the present invention, an apparatus for producing a flexographic printing plate comprises an inkjet printer adapted to pint flexographic material in a predetermined pattern onto a substrate and on to previously printed flexographic material;

a substrate support;

a system for causing relative movement between the inkjet printer and the substrate support;

a first curing system for partially curing part of each printed layer of flexographic material so as to immobilize it; and

a second curing system for additionally curing one or more lower printed layers before or while printing upper layers so as to reduce spreading of the lower printed layers.

We have developed a number of improved methods for producing flexographic printing plates which reduce or avoid the spreading problem set out above by introducing an additional curing stage for at least some of the lower printed layers.

The additional curing step could fully cure the one or more lower printed layers or further partially cure those layers, particularly if they still need to fully join with upper layers.

There are a variety of ways in which the additional curing step can be carried out and these will be described in more detail below in connection with the preferred examples. Briefly, however, methods include additionally curing the side(s) of the patterned material; utilizing a two component hardener which may optionally have a delayed activation to allow upper layers to be printed before curing commences; and using a radical curing starter.

In another approach, step (a) comprises printing edges of the predetermined pattern, the method further comprising a step (d) between steps (b) and (c) in which flexographic material is inkjet printed into areas defined by the printed edges whereby additional curing of the edges is achieved by implementing step (c) to repeat steps a, b, and d. The advantage of this is that a separate curing system for the additional curing step is not necessary since the system for curing at step (b) is used.

In some cases, the combination of the partial curing and additional curing is sufficient to produce a finished flexographic printing plate. However, in some cases, the method may further comprise step (e) of finally fully curing the fully printed flexographic material.

The finished form of the raised portions of the flexographic printing plate is important to achieve a high quality printed image in use. An important aspect of the finished form is the shape of the upwardly facing surface of each dot or other feature on the plate. US-A-2004/0131778 describes a method for improving the surface quality by depositing small drops of flexographic material on to the surface. However, this requires additional material and accurate printing resolution.

Preferably, therefore, the method further comprises mechanically shaping an upwardly facing surface of the partially cured material. This provides a much simpler approach to solving the problem and can be achieved using a variety of techniques including abrading, rolling and polishing.

### BRIEF DESCRIPTION OF THE DRAWINGS

Some examples of methods and apparatus according to the invention will now be described with reference to the accompanying drawings, in which:

FIG. 1 is a schematic side view of a first example of apparatus according to the invention;

FIG. 2 is a view similar to FIG. 1 but of a second example;

FIGS. 3a-3c illustrate successive stages in a third example of a method;

FIG. 4 is a schematic view of an example of the apparatus for carrying out the method shown in FIG. 3;

FIGS. 5a-5e illustrate successive stages in a fourth example of a method according to the invention;

FIGS. 6a-6d illustrate successive stages in a method according to a fifth example of the invention;

FIGS. 7a-7d illustrate successive stages in a sixth example of a method according to the invention;

FIGS. 8 and 9 illustrate schematically a drum and flat bed based system respectively utilizing a transparent support; and,

FIGS. 10-15 illustrate schematically different methods for mechanically shaping the upwardly facing surface of a previously deposited flexographic material.

### DETAILED DESCRIPTION OF THE EMBODIMENTS

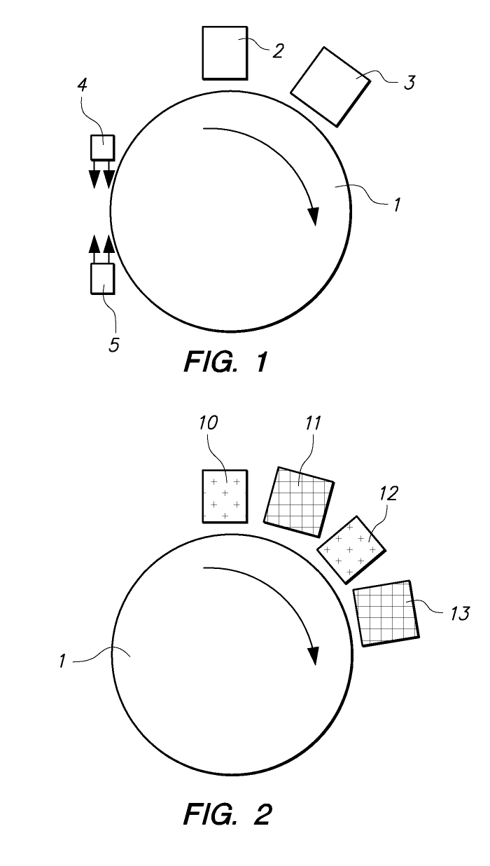

In the first example of apparatus according to the invention shown in FIG. 1, a rotatably mounted drum 1 is provided on which a printing plate (not shown) is mounted in use. The drum rotates in a clockwise direction in use so as to cause the plate to pass firstly under an inkjet printer 2 having an inkjet print bar which is controlled to print a flexographic material in a predetermined pattern on to the plate; and then under a pin curing device 3, typically a source of UV-C radiation. Further rotation of the drum 1 brings the plate into the vicinity of further UV-C sources 4, 5 which are arranged, as explained below, to irradiate sides of the material printed by the inkjet printer 2 so as to additionally cure the side walls. The drum 1 then further rotates to bring the plate back under the inkjet printer 2 to enable a further layer of flexographic material to be printed on to the previously printed layer. This process continues until the plate has been fully printed at which point it is detached from the drum 1 and conveyed to a final curing station where it is irradiated with UV-A (and optionally UV-C) to fully cure the deposited material.

As explained above, the sources 4, 5 are used to provide an additional curing stage which irradiates primarily the side of the built up material. In the first few layers this is not required as the normal pinning or immobilizing stage will halt the flow of flexographic material but after a small number of layers have been deposited this additional stage is introduced which primarily radiates the sides of the built up material thus curing them further enabling them to support the mass of the material deposited above them. This can be performed with one or more collimated UV light sources 4, 5 or from a light bar or an array of collimated UV LED's. With a collimated source the strength of radiation is proportional the cosine of the angle of the incident surface to the beam axis. Thus if the collimated source had an glancing angle of 5 deg then the top surface would receive only 9% of the radiation per unit area and a 30 degree to the normal wall would receive 90% of the radiation per unit area, almost 10 times as much radiation. To produce side wall hardening in all directions typically four directions would need to be illuminated. This would give the top surface four times as much radiation per unit area giving a radiation 2.5× to the side walls. However, the top surface would only receive it's radiation once (because it all be covered by the next deposited layer) and the side walls would receive their radiation every time the radiation was applied on successive layers. The lower layers may receive this side wall hardening 100 times. Thus this side wall hardening radiation need only be at a low level as the build up over all the layers gradually hardens the lower levels as is desired.

In a typical plate, the flexographic material will define a dot pattern with dot heights in the order of 0.5 mm and a spacing between dots of 100 micrometres.

The inkjet printer 2 and pin curing device 3 can be of conventional form as for example described in US-A-2004/0131778.

The flexographic material can also be of any conventional form. Examples of suitable compositions include

monomer/oligomer component, e.g. pentaerythritol triacrylate, isobornylacrylate, triethyleenglycoldivinylether

photoinitiator component, e.g. Genocure DEAP (Rahn), Irgacure 819 (Ciba-Geigy)

Inhibitor component, 2-methyl hydrochinon

Placticizer component, e.g. Sant5icizer 278 (Monsanto)

Elastomers binder, e.g. Cariflex TR226, Hycar1022(Goodrich).

FIG. 2 illustrates a second example of apparatus according to the invention. In this case, a drum 1 is provided as before and this transfers a printing plate (not shown) beneath a first inkjet printer 10, a first pin curing device 11, a second inkjet printer 12, and an optional second pin curing device 13. In this case, the first inkjet printer 10 prints a patterned layer of flexographic material incorporating a first component of a two component hardener. This printed pattern is then pin cured by the pin curing device 11, as before, and then passes under the second inkjet printer 12 which prints the second component of the two component hardener. Typically only a very small amount of this second component needs to be printed.

The two components will mix and thus the hardener will be activated causing partial curing of the patterned flexographic material. If necessary, the second component of the hardener can be pin cured using the pin curing device 30 although this is not essential.

Examples of two component hardeners are cationic link systems such as two part epoxy glues.

Preferably, the time constant of the hardener is set so that there is little or no hardening during the time needed to print up to about ten layers but after that time, the hardening commences so that the lower layers are hardened sufficiently to support the upper layers.

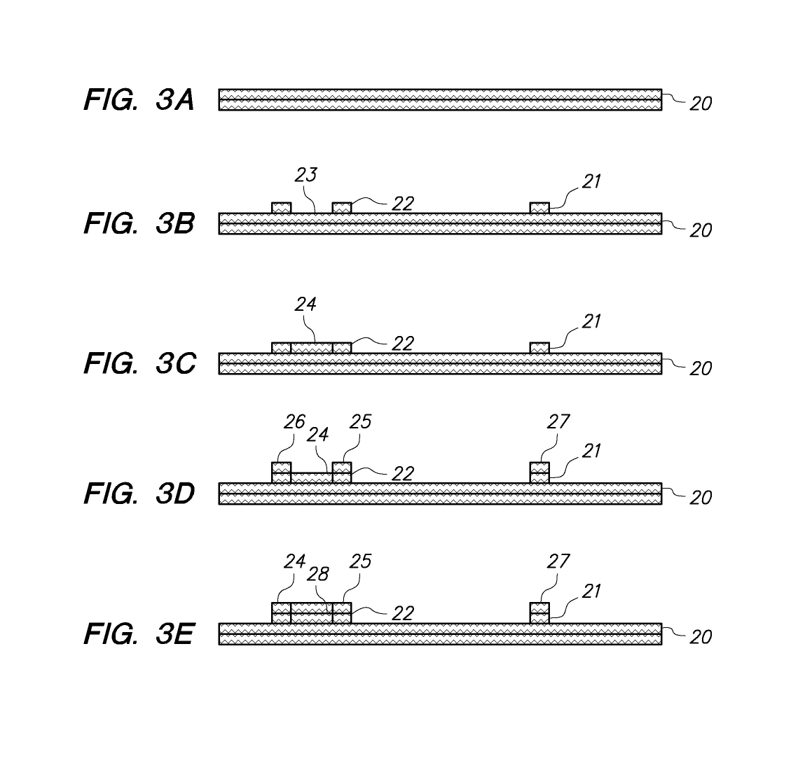

FIG. 3 illustrates an alternative method which can be implemented using the FIG. 1 apparatus. FIG. 3a illustrates the base plate 20 while FIG. 3b illustrates a first layer of flexographic material which has been printed on to the plate 20 and pin cured. This first layer comprises a single dot 21 and a continuous edge 22 surrounding a cavity 23.

In the next pass, the cavity 23 is filled with the flexographic material by the inkjet printer 2 as shown at 24 (FIG. 3c). This is again pin cured and then as shown at FIG. 3d a further edge layer 25 is printed on to the previous, pin cured edge 22 leaving a cavity 26. The dot 21 is also built up with a further layer 27. This structure is pin cured and then on the next pass (FIG. 3e) the cavity 24 is inkjet printed and filled with flexographic material 28 and then pin cured.

The result of this process is that each layer is printed twice, the first pass printing the edges of any areas and any single drop areas while the second pass fills in those areas between the edges. The edges will therefore receive twice the pinning radiation as the filled in areas and as such could be more cured and capable of supporting upper layers.

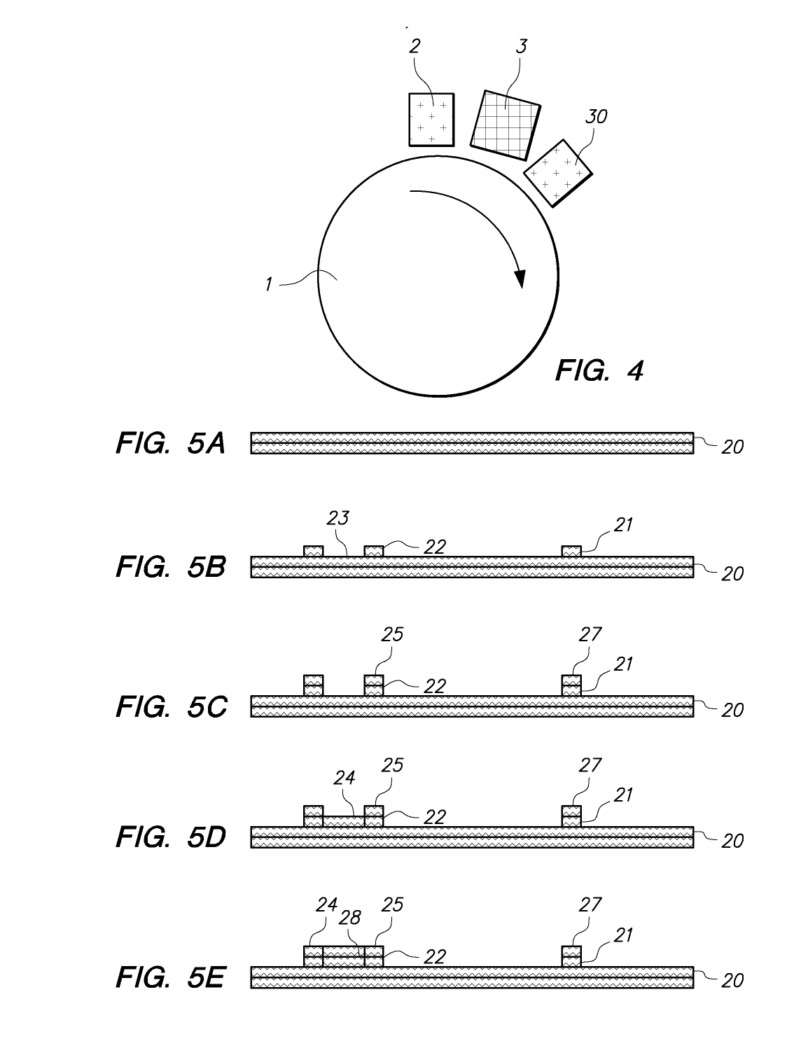

FIG. 4 illustrates an alternative apparatus for carrying out the method shown in FIG. 3 in which two inkjet printers 2, 30 are provided. The inkjet printer 2 is used to print edges and single points 21, 22, 25, 27 while the inkjet printer 30 is used to print the ink filled areas 24, 28.

The inkjet printer 2 will typically have a relatively high resolution while the inkjet printer 30 can have a lower resolution.

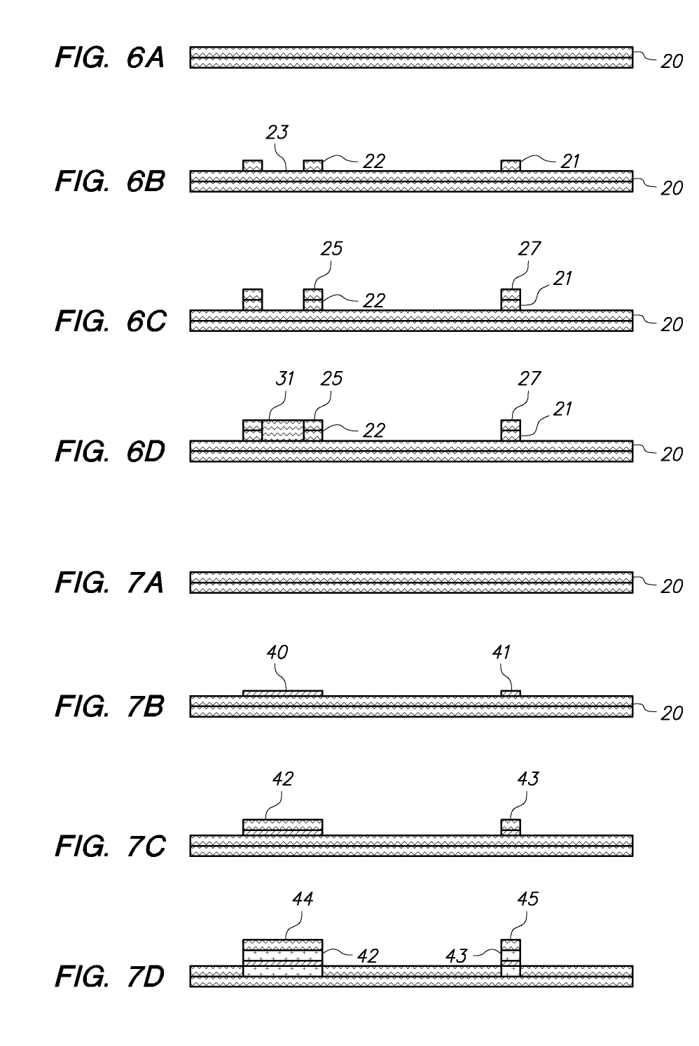

FIG. 5a-5e illustrate a variation of the method shown in FIG. 3. In this case, the edges and single points are printed first (FIGS. 5a-5c) and then any unfilled cavities are filled in subsequent steps (FIGS. 5d and 5e). As before, after each layer has been printed, it is pin cured and so it will readily be seen that the edges and single points 21, 22, 25, 27 will receive more cure radiation than the in fill 24, 28. Thus the side walls 22, 25 will be cured more strongly before the in fill layers 24, 28 are deposited in order to harden the walls to enable them to support the in fill layers. Further the in fill layers do not require any mobilizing or pin curing step after each layer has been deposited since the side walls provide the necessary immobilization.

In a further modification of the FIG. 5 example, shown in FIG. 6, the in fill does not need to be provided in a layered process but the cavity to be filled can be simply placed in line with the inkjet printing 2 and fully filled as shown in FIGS. 6c and 6d, the single in fill layer being illustrated at 31.

FIGS. 7a-7d illustrate an alternative approach to achieving curing which does not use a curing radiation. In this case, the plate 20 (FIG. 7a) is first printed with a radical starter 40, 41, such as a liquid suspended platinum for the curing process, the radical starter being printed in locations where flexographic ink is to be subsequently printed.

The flexographic material is then printed in successive layers in the desired pattern on the radical starter regions 40, 41 as shown at 42, 43; 44, 45.

A radical starter is a chemical that creates free radicals which then changes the properties of the surrounding chemicals (in this case curing) and that change creates more free radicals which sets up a chain reaction which progresses through the surrounding chemical, in this case up through the layers. Examples are described in U.S. Pat. No. 6,139,755, U.S. Pat. No. 5,300,587 and U.S. Pat. No. 5,366,573 incorporated herein by reference. Thus, the radical starter causes the flexographic layer above it to commence curing but the speed of curing is such that the layer will remain only partially cured by the time the next layer is printed. The result is that the lower layers are cured more than the upper layers so that they can support the upper layers.

It will be appreciated in this example that it can be implemented using the apparatus of FIG. 4 with the printer 2 being used to print flexographic material as before and the inkjet printer 30 being used to print the radical starter.

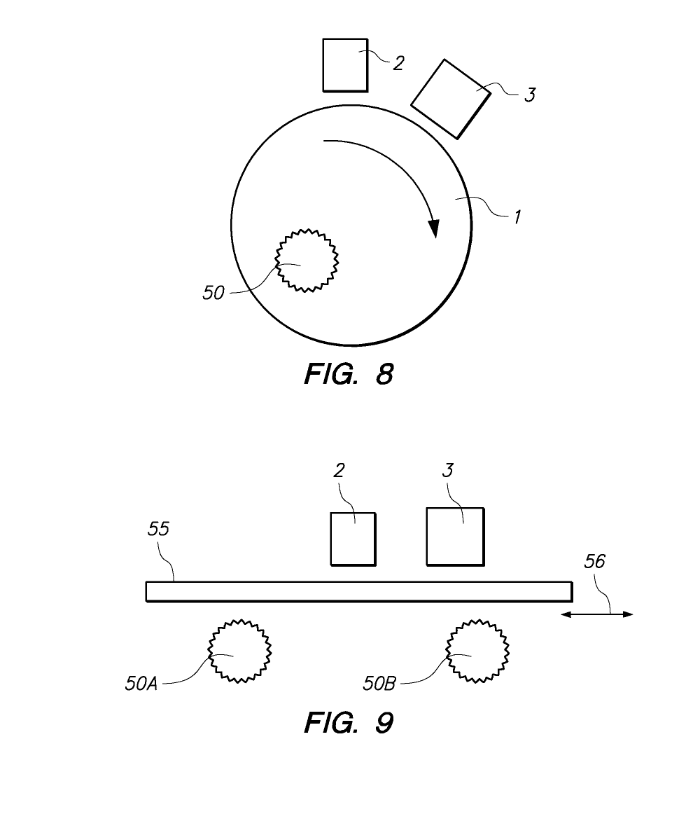

In the examples described so far in which the curing is achieved using a curing radiation, this has been generated from outside the drum and from the same side as the material is printed. In the embodiment shown in FIG. 8, the drum 1 is transparent to UV radiation so that a UV-A light source 50 can be positioned within the drum. Thus, the UV-A light source 50 replaces the pin curing device 3. Of course, the plate on which the flexographic material is printed must also be transparent to UV-A.

The advantage of this arrangement is that the printed flexographic material is irradiated from below which causes the lower layers to be cured as the printing of the upper layers occurs and thus the lower layers are capable of supporting the upper layers without distorting.

A suitable material for the drum 1 is borosilicate glass while the flexo plate is typically just a polymer layer made out of either the same material as the top surface or a slightly harder material than the upper surface of the drum.

FIG. 9 illustrates an alternative apparatus based on a flat bed arrangement which is equivalent to the drum arrangement of FIG. 8. In this case, the drum is replaced by a flat bed support 55 on which a flexographic plate (not shown) is mounted. Two UV-A light sources 50A, 50B are provided beneath the support 55 which is transparent to UV-A. The support 55 can be moved to and fro as indicated by an arrow 56 so that successive layers of flexographic material can be laid down and pin cured and additionally cured as described above.

We now consider how to improve the form of the upwardly facing surface of the printed flexographic material.

To avoid the effect of a non-flat surface caused by the meniscus of the flexographic material it is desirable to flatten the printed surface to create a more plateaux type surface. As at least the most recently printed flexographic material is not fully cured and has only been pin cured it is still soft and can be moulded, cut or eroded into the desired plateau shape.

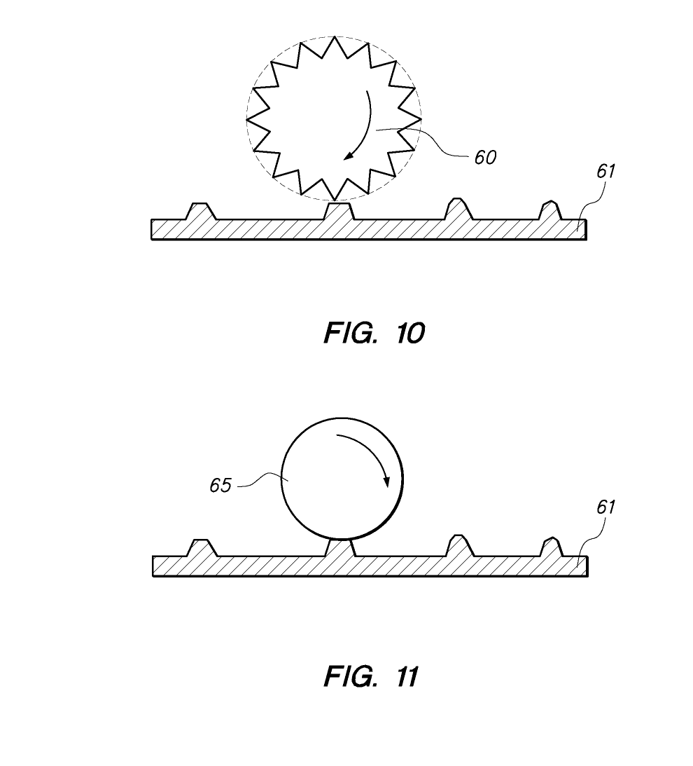

In one embodiment (FIG. 10) the plateau shape can be eroded onto the flexographic material with a rotating abrasive cylinder 60 which is held at the desired height above the plate 61. Material above the desired height is then removed by the abrasive cylinder. The remaining flexographic material is then fully cured with UV-A and UV-C radiation.

In this example, the plate 61 is held stationary while the cylinder 60 rotates and when the desired shaping has been completed, the plate 61 is moved to bring the next part of the flexographic material into line with the cylinder for shaping.

In another embodiment (FIG. 11) the desired plateau shape is pressed onto the flexographic material by a polished cylinder 65 held at the desired height. As the flexographic material is partially cured the plateau shape is retained on contact with the cylinder. The remaining flexographic material is then fully cured with UV-A and UV-C radiation.

In this case, the plate 61 is moved laterally during the polishing process while the cylinder 65 is rotated so that its peripheral speed matches that of the plate 61.

In an alternative to the FIG. 11 example, the polished cylinder 65 is rotated such that its peripheral speed is faster than the speed of movement of the plate 61.

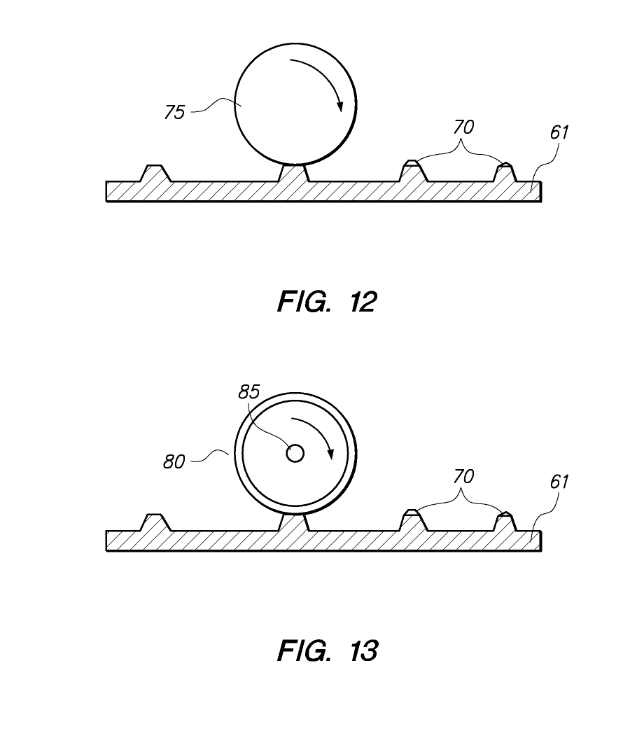

In the FIG. 12 example the final layer or layers of flexographic material 70 are either not pin cured or only slightly pin cured and then passed under a heated polished cylinder 75 held at the desired height. The heat then cures the flexographic material while it is held in the correct shape and ensures that the flexographic material obtains its shape. The cylinder 75 can be rotated with a peripheral speed which matches or is faster than the lateral speed of movement of the plate 61. In the FIG. 13 example, a polished cylinder 80 is provided which is transparent to UV radiation and the UV-A light source 85 is located within the cylinder 80. The cylinder 80 is rotated so that its peripheral surface speed matches or alternatively faster than the speed of movement of the plate 61. The final layers 70 is a flexographic material which have not been pin cured or slightly pin cured are then both then cured by radiation and polished to the desired shape.

In a modification of FIG. 13, the transparent cylinder could also be heated.

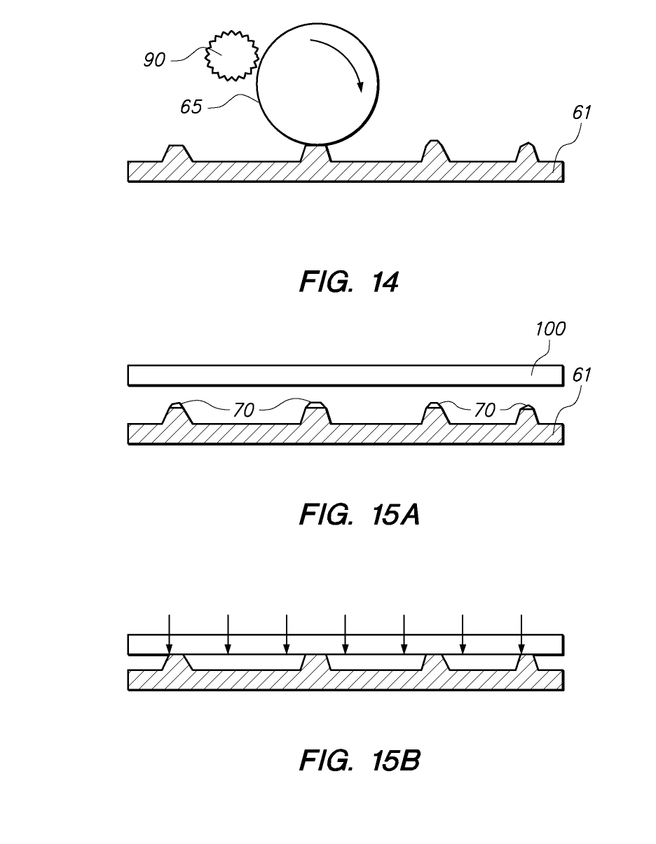

In all the examples described with reference to FIGS. 10 to 13, the cylinder can be continuously cleaned whilst it is not in contact with the flexographic material, as shown in FIG. 14. In that case, a cleaning roller 90 is located adjacent to the surface of the cylinder 65 and is rotated such that its peripheral speed is different from that of the cylinder 65 and thus any flexographic material adhering to the cylinder 65 is removed.

FIG. 15 illustrates another embodiment for shaping the flexographic material. In this case, as in some of the previous examples, the last layer or layers of the flexographic material are not pin cured or are only partially pin cured as shown at 70 (FIG. 15a).

A flat sheet 100 of transparent material, such as borosilicate float glass, is then brought into contact with, and held at the desired distance from, the flexographic plate 61, to force the plateau shape, and UV-A light is transmitted through the transparent sheet 100 to partially cure the flexographic material so it will hold it's shape when the sheet of glass is removed (FIG. 15b). The remaining flexographic material is then fully cured with UV-C radiation.

In a modification of the FIG. 15 example, the sheet 100 could be replaced by a heated, polished sheet. The heat from the polished sheet then cures the non or partially pin cured flexographic material.

In the embodiments utilizing a flat sheet, a defined pattern could be embossed on the sheet face if a non-polished finish is desired.

1. A method of producing a flexographic printing plate, the method comprising:
a) inkjet printing a layer of flexographic material in a predetermined pattern onto a substrate;
b) partially curing at least part of the printed layer of flexographic material so as to immobilize it on the substrate; and
c) repeating (a) and (b) so as to print and partially cure one or more further layers of flexographic material in the predetermined pattern on the previous layer(s),
characterized by additionally curing one or more lower printed layers before or while printing one or more upper layers so as to reduce spreading of the lower printed layer(s).

2. A method according to claim 1, wherein the additional curing is confined to the side(s) of the patterned material.

3. A method according to claim 2, wherein the additional curing step is carried out by illuminating the side(s) of the patterned the material with curing radiation in at least two different directions.

4. A method according to claim 3, wherein the illumination is carried out in at least four different directions.

5. A method according to claim 1, wherein the additional curing step is carried out by utilizing a two component hardener, a first component being provided in the flexographic material and the second component being supplied to the lower printed layer(s) after the layer(s) has been partially cured in (b).

6. A method according to claim 5, wherein the components of the two component hardener are chosen so that curing of the lower printed layer(s) commences after at least two further layer(s) of printed flexographic material have been printed following supply of the second component.

7. A method according to claim 1, wherein (a) comprises printing edges of the predetermined pattern, the method further comprising, between (b) and (c), inkjet printing flexographic material into areas defined by the printed edges whereby additional curing of the edges is achieved by implementing (c) to repeat (a), (b), and (d).

8. A method according to claim 7, wherein the edges are printed at a higher resolution than the area defined by the edges.

9. A method according to claim 1, wherein (a) comprises printing edges of the predetermined pattern, the method further comprising inkjet printing flexographic material into areas defined by the edges after the edges have been fully printed.

10. A method according to claim 1, wherein the additional curing is caused by a radical curing starter provided on the substrate in areas in which flexographic material is to be printed.

11. A method according to claim 1, wherein the additional curing comprises irradiating one or more lower layers of the printed flexographic material with curing radiation through the substrate.

12. A method according to claim 1, the method further comprising (e) finally, fully curing the fully printed flexographic material.

13. A method according to claim 12, wherein (b) and (e) are carried out by exposing the material to curing radiation.

14. A method according to claim 13, wherein the curing radiation used in (b) differs from that used in (e) by one or more of wavelength, intensity, and exposure times.

15. A method according to claim 14, wherein UV-C radiation is used in (b), and UV-A radiation in (e).

16. A method according to claim 1, wherein after all the flexographic material has been printed the method further comprises mechanically shaping an upwardly facing surface of the partially cured material.

17. A method according to claim 12, wherein the shaping step is carried out before (e).

18. A method according to claim 16, wherein the shaping comprises flattening.

19. A method according to claim 16, wherein the shaping is carried out by one or more of abrading, rolling or polishing the upwardly facing surface of the partially cured material.

20. An apparatus for producing a flexographic printing plate, the apparatus comprising an inkjet printer adapted to pint flexographic material in a predetermined pattern onto a substrate and on to previously printed flexographic material;
a substrate support;
a system for causing relative movement between the inkjet printer and the substrate support;
a first curing system for partially curing part of each printed layer of flexographic material so as to immobilize it; and
a second curing system for additionally curing one or more lower printed layers before or while printing uppers layers so as to reduce spreading of the lower printed layers.

21. An apparatus according to claim 20, wherein the second curing system comprises a curing radiation source and a system for causing the radiation from the source to impinge on the side(s) of the patterned material on the substrate.

22. An apparatus according to claim 20, wherein the second curing system comprises a system for supplying a second component of a two component hardener to previously printed flexographic material containing a first component of the two component hardener.

23. An apparatus according to claim 20, wherein the second curing system comprises a source of curing radiation which generates radiation that is transmitted in use through the substrate.

24. An apparatus according to claim 20, further comprising a system for shaping the upper face of the partially cured material.
